(19) United States
(12) Patent Application Publication
(10) Pub. No.: US 2008/0198457 A1
(43) Pub. Date: Aug. 21, 2008

(54) DUST-PROOF, REFLECTING MIRROR AND OPTICAL APPARATUS COMPRISING SAME

(75) Inventors: Yasuhiro SAKAI, Saitama (JP); Kazuhiro YAMADA, Saitama (JP); Hiroyuki NAKAYAMA, Tokyo (JP); Akihiko KOGUCHI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/029,623

(22) Filed: Feb. 12, 2008

(30) Foreign Application Priority Data
Feb. 20, 2007 (JP) 2007-39661

(51) Int. Cl. G02B 1/10; G02B 5/08

(52) U.S. Cl. 359/507

(57) ABSTRACT

A dust-proof, reflecting mirror comprising a reflecting mirror substrate, a dust-proof coating having fine surface roughness, which is formed on a reflecting surface of the reflecting mirror substrate, and an outermost water-repellent or water/oil-repellent coating.

### FIELD OF THE INVENTION

The present invention relates to a dust-proof, reflecting mirror having excellent resistance to the attachment of dust, and an optical apparatus comprising such a dust-proof, reflecting mirror.

### BACKGROUND OF THE INVENTION

Reflecting mirrors are used in various optical apparatuses. For instance, a single-lens-reflection camera has a reflecting mirror for obtaining finder image in a light path, and a projector has a reflecting mirror in a light path from a lamp to a projection lens.

However, the attachment of foreign matter such as dust on a mirror surface is likely to lower the reflectance of the reflecting mirror, and generate image defects. Single-lens-reflection, lens-exchangeable cameras comprise air-blowing apparatus for blowing foreign matter away from the reflecting mirrors. However, the blown foreign matter tends to remain in the cameras, needing frequent cleaning. Some optical apparatuses that cannot easily be cleaned are provided with dust-proof structures for closing light paths, or dust-removing mechanisms, but their designs sometimes do not permit the dust-proof structures. In addition, the dust-proof structures make the optical apparatuses more expensive. Thus, the mechanical removal of dust poses problems such as increased cost, weight and current consumption, etc.

In such circumstances, JP 6-308421 A proposes an image-reading apparatus comprising a light source emitting a light for illuminating a manuscript, and pluralities of optical members for reflecting and transmitting a light flux from the manuscript to an imaging drum, on which the image of the manuscript is formed, at least one optical member having a dust-proof coating of a fluorine-containing oil (for instance, perfluoropolyether, etc.). This dust-proof coating, however, fails to have sufficient durability because the fluorine-containing oil easily evaporates.

JP 2005-234447 A proposes an optical member having an antireflection coating obtained by treating a zinc-compound-containing gel coating with water at 20° C. or higher, and JP 2005-275372 A proposes an optical member having an antireflection coating obtained by treating an alumina-containing gel coating with hot water. These antireflection coatings are dust-proof because they have fine roughness on the surface, but it has been found that sufficient dust resistance for the reflecting mirror cannot be obtained when only such antireflection coating is formed.

### OBJECT OF THE INVENTION

Accordingly, an object of the present invention is to provide a dust-proof, reflecting mirror having excellent dust resistance, and an optical apparatus comprising such dust-proof, reflecting mirror.

### DISCLOSURE OF THE INVENTION

As a result of intense research in view of the above object, the inventors have found that a dust-proof, reflecting mirror having excellent dust resistance can be obtained by forming a dust-proof coating having fine surface roughness and an outermost water-repellent or water/oil-repellent coating on a reflecting surface of a reflecting mirror substrate. The present invention has been completed based on such finding.

Thus, the dust-proof, reflecting mirror of the present invention comprises a reflecting mirror substrate, a dust-proof coating having fine surface roughness, which is formed on a reflecting surface of the reflecting mirror substrate, and an outermost water-repellent or water/oil-repellent coating.

The dust-proof coating preferably comprises at least one selected from the group consisting of alumina, zinc oxide and zinc hydroxide. The roughness of the dust-proof coating is preferably constituted by large numbers of irregularly distributed projections having a petal-like shape and grooves therebetween.

The dust-proof, reflecting mirror preferably comprises an antistatic coating as a primer layer for the dust-proof coating, to improve dust repellency. The antistatic coating preferably has surface resistivity of 1×10¹³ Ω/square or less. The water-repellent or water/oil-repellent coating preferably has a thickness of 0.4-100 nm.

The dust-proof, reflecting mirror according to a preferred embodiment of the present invention has an outermost surface having three-dimensional, average surface roughness SRa of 1-100 nm and a specific surface area of 1.05 or more.

The optical apparatus of the present invention comprises the above dust-proof, reflecting mirror.

### BRIEF DESCRIPTION OF THE DRAWINGS

FIG. 1 is a schematic view showing an optical engine of a liquid-crystal-type rear projector equipped with the dust-proof, reflecting mirror of the present invention.

FIG. 2 is a cross-sectional view showing the layer structure of the dust-proof, reflecting mirror of Example 1.

FIG. 3 is a graph showing the reflectance of the reflecting mirrors of Example 1 and Comparative Examples 3 and 4.

### DESCRIPTION OF THE PREFERRED EMBODIMENTS

[1] Layer Structure of Dust-Proof, Reflecting Mirror

The dust-proof, reflecting mirror comprises a reflecting mirror substrate, a dust-proof coating having fine surface roughness, which is formed on a reflecting surface of the reflecting mirror substrate, and an outermost water-repellent or water/oil-repellent coating.

(1) Reflecting Mirror Substrate

The reflecting mirror substrate having a reflecting surface may be a substrate made of a metal such as aluminum, a laminate substrate comprising a reflecting metal coating on a glass or resin layer, etc., though not restrictive. The glass used for the laminate substrate may be, for instance, silica, borosilicate glass, soda-lime glass, etc. The resins used for the laminate substrate may be, for instance, transparent polymers such as polymethacrylates and polycarbonates, heat-resistant resins such as polyphenylene sulfide, etc. The reflecting metal coating for the laminate substrate may be an aluminum layer, a silver coating, etc., and the aluminum layer is preferable. The shape and size of the reflecting mirror substrate may be properly selected depending on applications.

(2) Dust-Proof Coating

The dust-proof coating has fine surface roughness. In general, the larger three-dimensional, average surface roughness SRa (index of fine surface roughness density) the dust-proof coating has, the larger effect of reducing an intermolecular force of dust particles attached to the dust-proof coating can be obtained. An attraction force F₁ by contact electrification between uniformly charged spherical dust particles and a dust-proof, reflecting mirror is generated by the chemical potential difference between them. The attraction force F₁ by contact electrification is expressed by the following general formula (1):

$${F}_{1} = - \frac{{πɛ}_{0} {V}_{C}^{2} {A}^{2} {k}^{2} {D}^{2}}{457 {( {z}_{0} + b )}^{8}} , \qquad ( 1 )$$

wherein ε₀ is 8.85×10⁻¹² (F/m), a dielectric constant of vacuum, Vc is a contact potential difference between a dust-proof coating of the dust-proof, reflecting mirror and a dust particle, A is a Hamaker constant representing the amount of van der Waals interaction, k is a coefficient represented by the formula of k=k₁+k₂, wherein k₁ and k₂ are represented by k₁=(1−ν₁²)/E₁ and k₂=(1−ν₂²)/E₂, respectively, wherein ν₁ and ν₂ are Poisson ratios of the dust-proof coating and the dust particle, and E₁ and E₂ are Young's modulus of the dust-proof coating and the dust particle, D is a diameter of the dust particle, z₀ is the distance between the dust-proof coating and the dust particle, and b is SRa of the dust-proof coating. As is clear from the formula (1), increasing b (SRa of the dust-proof coating) leads to decrease in the attraction force F₁ by contact electrification. The Hamaker constant A is approximated by a function of a refractive index; the smaller the refractive index, the smaller the Hamaker constant A. The refractive index of the dust-proof coating is preferably 1.50 or less, more preferably 1.45 or less.

When the dust-proof coating has SRa of 1 nm or more, a dust particle attached to the dust-proof coating has sufficiently small intermolecular force and attraction force F₁ by contact electrification. When the SRa exceeds 100 nm, light scattering occurs, becoming unsuitable for optical apparatuses. Thus, the SRa is preferably 1-100 nm, more preferably 8-80 nm, particularly 10-50 nm. The SRa is centerline-average roughness (Ra: arithmetic-average roughness) measured according to JIS B0601 by an atomic force microscope (AFM), which is three-dimensionally expanded. The SRa is expressed by the following formula (2):

$$SRa = \frac{1}{{S}_{0}} {\int }_{{Y}_{B}}^{{Y}_{T}} {\int }_{{X}_{L}}^{{X}_{R}} \vert F ( X , Y ) - {Z}_{0} \vert d X d Y , \qquad ( 2 )$$

wherein a range of X_{L} to X_{R} represents an X-coordinate range of the measured surface, a range of Y_{B} to Y_{T} represents a Y-coordinate range of the measured surface, S₀ represents an area of |X_{R}−X_{L}|×|Y_{T}−Y_{B}| when the measured surface is flat, X represents an X coordinate, Y represents a Y coordinate, F(X,Y) represents a height at the measured point (X,Y), and Z₀ represents an average height in the measured surface.

The specific surface area S_{R} of the dust-proof coating is preferably 1.05 or more, more preferably 1.15 or more. The S_{R} is expressed by the following formula (3):

S_{R}=S/S₀ (3),

wherein S₀ is a surface area of the dust-proof coating when it is assumed as flat, and S is the measured surface area of the dust-proof coating. S is determined by summing surface areas ΔS of small triangular regions obtained by dividing the dust-proof coating. The specific surface area S_{R} is preferably on a level not causing the scattering of light.

The dust-proof coating includes, for instance, a coating obtained by treating an alumina-containing gel coating with hot water, and a coating obtained by treating a zinc-compound-containing gel coating with water at 20° C. or higher. The former coating has surface roughness constituted by irregular combinations of large numbers of extremely fine, irregular-shaped projections and grooves therebetween, which are formed by treating a surface layer of alumina-containing gel coating with hot water. Because the projections have a petal-like shape, this coating may be called a petal-like alumina coating. The latter coating has surface roughness constituted by irregular combinations of extremely fine, precipitate projections and recesses therebetween, which are formed by treating a surface layer of zinc-compound-containing gel coating with water at 20° C. or higher. This coating is called a zinc compound coating.

The petal-like alumina coating is preferably based on alumina, more preferably composed of alumina only, but it may contain at least one optional component selected from the group consisting of zirconia, silica, titania, zinc oxide and zinc hydroxide, if necessary. The amount of the optional component is not restrictive, as long as it is within a range in which fine roughness is formed by treating the alumina-containing gel coating with hot water without deteriorating transparency. Specifically, the amount of the optional component is preferably 0.01-50% by mass, more preferably 0.05-30% by mass, based on 100% by mass of the entire dust-proof coating.

The zinc compound coating is preferably based on zinc oxide and/or zinc hydroxide, and may contain at least one optional component selected from the group consisting of alumina, zirconia, silica and titania, if necessary. The amount of the optional component is not particularly restrictive, as long as fine roughness is formed without deteriorating transparency by treating the zinc-compound-containing gel coating with water at 20° C. or higher. The amount of the optional component is preferably 0.01-50% by mass, more preferably 0.05-30% by mass, based on 100% by mass of the entire dust-proof coating.

The roughness of the dust-proof coating can be observed by a scanning electron microscope (SEM) or AFM. The thickness of the dust-proof coating, which is the distance from the fine rough surface to the bottom, is preferably 0.05-3 μm.

(3) Antistatic Coating

The dust-proof, reflecting mirror may have an antistatic coating inside and/or outside the dust-proof coating, to reduce a Coulomb force, one of the causes of attracting dust, thereby improving dust repellency. The antistatic coating is preferably formed as a primer layer for the dust-proof coating.

An electrostatic attraction force F₂ between a uniformly charged spherical dust particle and the dust-proof, reflecting mirror is expressed by the following general formula (4):

$${F}_{2} = - \frac{1}{4 {πɛ}_{0}} \cdot \frac{{q}_{1} {q}_{2}}{{r}^{2}} , \qquad ( 4 )$$

wherein q₁ represents the charge (C) of the dust-proof, reflecting mirror, q₂ represents the charge (C) of the dust particle, r represents the radius of the dust particle, and ε₀ represents 8.85×10⁻¹² (F/m), a dielectric constant of vacuum. As is clear from the formula (4), decrease in the amount of charge in the dust-proof, reflecting mirror and the dust particle results in the reduction of the electrostatic attraction force F₂. To reduce the amount of charge, the antistatic coating is formed.

An electric imaging force F₃ between a uniformly charged spherical dust particle and the dust-proof, reflecting mirror is expressed by the following general formula (5):

$${F}_{3} = - \frac{1}{4 {πɛ}_{0}} \cdot \frac{( ɛ - {ɛ}_{0} )}{( ɛ + {ɛ}_{0} )} \cdot \frac{{q}^{2}}{{( 2 r )}^{2}} , \qquad ( 5 )$$

wherein ε₀ represents 8.85×10⁻¹² (F/m), a dielectric constant of vacuum, ε represents the dielectric constant of the dust-proof, reflecting mirror, q represents the charge of the dust particle, and r represents the radius of the dust particle. The electric imaging force F₃ is a force generated by charge induced when a charged dust particle nears an uncharged dust-proof, reflecting mirror. Because the electric imaging force F₃ substantially depends on the chargeability of dust particles, it can be decreased by removing charge from the attached dust particles by the antistatic coating.

The surface resistivity of the antistatic coating is preferably 1×10¹³ Ω/square or less, more preferably 1×10¹² Ω/square or less. The antistatic coating preferably has a refractive index, about a middle of those of the reflecting mirror substrate and the dust-proof coating. The antistatic coating preferably has a thickness of 0.01-3 μm.

Materials for the antistatic coating are not particularly restrictive as long as they are colorless and highly transparent, and may be at least one conductive inorganic material selected from the group consisting of antimony oxide, indium oxide, tin oxide, zinc oxide, tin-doped indium oxide (ITO) and antimony-doped tin oxide (ATO). The antistatic coating may be a composite coating comprising fine particles of the above conductive inorganic materials (fine, conductive, inorganic particles) and a binder, or a dense coating, such as a vapor-deposited coating, made of the above conductive inorganic materials. A monomer or an oligomer polymerizable to the binder is preferable, and metal alkoxides or their oligomers, ultraviolet- or heat-curable compounds (for instance, acrylates) are preferably used.

(4) Water-Repellent or Water/Oil-Repellent Coating

The dust-proof, reflecting mirror comprises a water-repellent or water/oil-repellent coating (simply called “water/oil-repellent coating”) as an outermost layer. The water/oil-repellent coating has a function to reduce the attachment of dust particles by a liquid bridge force, a force of a liquid condensing in contact regions between the dust-proof, reflecting mirror and the dust particles. The liquid bridge force F₄ between the spherical dust particle and the dust-proof, reflecting mirror is expressed by the following general formula (6):

F₄=−2πγD (6),

wherein γ represents the surface tension of the liquid, and D represents the diameter of the dust particle. The formation of the water/oil-repellent coating on the dust-proof coating reduces the attachment of water or oil, resulting in decrease in the attachment of dust particles due to the liquid bridge force F₄.

In general, between the contact angle of water on a rough surface and that on a flat surface, there is a relation approximated by the following formula (7):

cos θ_{γ}=γ cos θ (7),

wherein θ_{γ} represents the contact angle of water on a rough surface, θ represents the contact angle of water on a flat surface, and γ represents a surface area factor. Because γ is usually larger than 1, θ_{γ} is smaller than θ when θ<90°, and larger than θ when θ>90°. This means that increase in the area of a water-repellent surface by roughening leads to higher water repellency. Thus, the formation of the water/oil-repellent coating on the dust-proof coating without losing the fine roughness of the dust-proof coating provides a high water-repelling effect. This is true of oil repellency.

Materials for the water/oil-repellent coating are not particularly restricted as long as they are colorless and highly transparent, including fluorine-containing, organic or inorganic compounds, fluorine-containing, organic-inorganic hybrid polymers, fluorinated pitch (for instance, CFn, wherein n is 1.1-1.6), etc.

The fluorine-containing organic compounds include, for instance, fluororesins, which may be polymers of fluorine-containing olefinic monomers, and copolymers of fluorine-containing olefinic monomers and comonomers. Such (co)polymers include polytetrafluoroethylene, polychlorotrifluoroethylene, polyvinylidene fluoride, polyvinyl fluoride, a tetraethylene-hexafluoropropylene copolymer, an ethylene-tetrafluoroethylene copolymer, a tetrafluoroethylene-perfluoroalkylvinyl ether copolymer, an ethylene-chlorotrifluoroethylene copolymer, a tetrafluoroethylene-hexafluoropropylene-perfluoroalkylvinyl ether copolymer, etc. The fluororesins may be obtained by polymerizing commercially available fluorine-containing compositions, such as Opstar available from JSR Corporation, CYTOP available from Asahi Glass Co., Ltd., etc.

The fluorine-containing inorganic compound may be at least one selected from the group consisting of LiF, MgF₂, CaF₂, AlF₃, BaF₂, YF₃, LaF₃ and CaF₃. These fluorine-containing inorganic compounds are available from, for instance, Canon Optron Inc.

The fluorine-containing organic-inorganic hybrid polymers include organosilicon polymers having fluorocarbon groups, which may be polymers obtained by hydrolyzing fluorine-containing silane compounds having fluorocarbon groups. The fluorine-containing silane compounds are expressed by the following formula (8):

CF₃(CF₂)ₐ(CH₂)₂SiR_{b}X_{c} (8),

wherein R represents an alkyl group, X represents an alkoxyl group or a halogen atom, a represents an integer of 0-7, b represents an integer of 0-2, c represents an integer of 1-3, and b+c=3. Specific examples of the compounds expressed by the formula (8) include CF₃(CH₂)₂Si(OCH₃)₃, CF₃(CH₂)₂SiCl₃, CF₃(CF₂)₅(CH₂)₂Si(OCH₃)₃, CF₃(CF₂)₅(CH₂)₂SiCl₃, CF₃(CF₂)₇(CH₂)₂Si(OCH₃)₃, CF₃(CF₂)₇(CH₂)₂SiCl₃, CF₃(CF₂)₇(CH₂)₃SiCH₃(OCH₃)₂, CF₃(CF₂)₇(CH₂)₂SiCH₃Cl₂, etc. The organosilicon polymers are, for instance, Novec EGC-1720 available from Sumitomo 3M Ltd. XC98-B2472 available from GE Toshiba Silicone, etc.

The thickness of the water/oil-repellent coating is preferably 0.4-100 nm, more preferably 10-80 nm. With the thickness of 0.4-100 nm, the water/oil-repellent coating permits the dust-proof coating to have SRa and S_{R} in the above ranges. Thus, the formation of the water/oil-repellent coating having a thickness of 0.4-100 nm as an outermost layer reduces the electrostatic attraction force F₂ and the electric imaging force F₃, without hindering the function of the dust-proof coating with fine roughness to reduce the intermolecular force and the attraction force F₁ by contact electrification, thereby further improving the dust repellency. When the water/oil-repellent coating is thinner than 0.4 nm, it is impossible to obtain sufficient water/oil repellency, and the reduction of the electric imaging force F₃ that can be expected, for instance, when the fluororesin is used. When the water/oil-repellent coating is thicker than 100 nm, the fine roughness of the dust-proof coating does not appear on the surface, resulting in decrease in the dust repellency. The refractive index of the water/oil-repellent coating is preferably 1.5 or less, more preferably 1.45 or less.

(5) Examples of Layer Structure

The preferred examples of the layer structure of the dust-proof, reflecting mirror are water/oil-repellent coating/dust-proof coating/reflecting surface of reflecting mirror substrate, water/oil-repellent coating/dust-proof coating/antistatic coating/reflecting surface of reflecting mirror substrate, etc., though not restrictive.

[2] Production Method of Dust-Proof, Reflecting Mirror

(1) Formation of Dust-Proof Coating

(a) Formation of Petal-Like Alumina Coating

The petal-like alumina coating can be formed by applying a coating solution containing an aluminum compound to the reflecting mirror substrate to form an alumina-containing gel coating, and treating the gel coating with hot water. Because this method produces the petal-like alumina coating without burning at high temperatures, the petal-like alumina coating can be formed even on a reflecting mirror substrate without heat resistance.

The aluminum compounds include aluminum alkoxides, aluminum nitrate, aluminum sulfate, etc., and are preferably aluminum alkoxides. The production of the petal-like alumina coating using aluminum alkoxides, which is described in JP 9-202649 A, JP 3688042 B and JP 9-202651 A, will be explained in detail below.

The aluminum alkoxides include aluminum trimethoxide, aluminum triethoxide, aluminum triisopropoxide, aluminum tri-n-butoxide, aluminum tri-sec-butoxide, aluminum tri-tert-butoxide, aluminum acetyl acetate, oligomers obtained by their partial hydrolysis, etc.

The coating solution may contain at least one optional component selected from the group consisting of zirconium alkoxides, alkoxyl silanes, titanium alkoxides and zinc compounds.

The zirconium alkoxides include zirconium tetramethoxide, zirconium tetraethoxide, zirconium tetra-n-propoxide, zirconium tetraisopropoxide, zirconium tetra-n-butoxide, zirconium tetra-t-butoxide, etc.

The alkoxyl silanes are preferably expressed by the following general formula (9):

Si(OR₁)ₓ(R₂)₄₋ₓ (9),

wherein R₁ represents an alkyl group having 1-5 carbon atoms or an acyl group having 1-4 carbon atoms, R₂ represents an organic group having 1-10 carbon atoms, and x represents an integer of 2-4. The alkyl group may be a methyl group, an ethyl group, an n-propyl group, an i-propyl group, an n-butyl group, a sec-butyl group, a tert-butyl group, etc. The acyl group may be an acetyl group. The organic group may be unsubstituted hydrocarbon groups such as a methyl group, an ethyl group, an n-propyl group, an i-propyl group, an n-butyl group, a tert-butyl group, an n-hexyl group, a cyclohexyl group, an n-octyl group, a tert-octyl group, an n-decyl group, a phenyl group, a vinyl group, an allyl group, etc., and substituted hydrocarbon groups such as a γ-chloropropyl group, a CF₃CH₂— group, a CF₃CH₂CH₂— group, a C₂F₅CH₂CH₂— group, a C₃F₇CH₂CH₂CH₂— group, a CF₃OCH₂CH₂CH₂— group, a C₂F₅OCH₂CH₂CH₂— group, a C₃F₇OCH₂CH₂CH₂— group, a (CF₃)₂CHOCH₂CH₂CH₂— group, a C₄F₉CH₂OCH₂CH₂CH₂— group, a 3-(perfluorocyclohexyloxy)propyl, a H(CF₂)₄CH₂OCH₂CH₂CH₂— group, a H(CF₂)₄CH₂CH₂CH₂— group, a γ-glycidoxypropyl group, a γ-mercaptopropyl group, a 3,4-epoxycyclohexylethyl group, a γ-methacryloyloxypropyl group, etc.

The titanium alkoxides include tetramethoxy titanium, tetraethoxy titanium, tetra-n-propoxy titanium, tetraisopropoxy titanium, tetra-n-butoxy titanium, tetraisobutoxy titanium, etc.

The zinc compounds include zinc acetate, zinc chloride, zinc nitrate, zinc stearate, zinc oleate, zinc salicylate, etc. Among them, zinc acetate and zinc chloride are preferable.

The percentage of the optional component is preferably 0.01-50% by mass, more preferably 0.05-30% by mass, based on the total amount (100% by mass) of the aluminum alkoxide and the optional component.

The coating solution preferably contains as a stabilizing agent β-diketones such as acetyl acetone, ethyl acetoacetate, etc.; alkanol amines such as monoethanolamine, diethanolamine, triethanolamine, etc.; metal alkoxides, etc. The coating solution may contain an organic solvent such as methanol, ethanol, propanol, butanol, methyl Cellosolve, ethyl Cellosolve, etc.

The preferred mixing ratio of the metal alkoxides (aluminum alkoxide+optional component), the organic solvent, the stabilizing agent and water is 1/(10−100)/(0.5-2)/(0.1−5).

The coating solution may contain nitric acid, hydrochloric acid, sulfuric acid, phosphoric acid, acetic acid, ammonia, etc. as a catalyst for accelerating the hydrolysis and dehydration condensation of an alkoxyl group. The molar ratio of the catalyst to the metal alkoxide is preferably 0.0001-1.

The coating solution may contain a water-soluble polymer, if necessary. The water-soluble polymer includes polyvinyl pyrrolidone, polyvinyl alcohol, polymethyl vinyl ether, polyethylene glycol, polypropylene glycol, etc. When an alumina gel coating obtained from a coating solution containing the water-soluble polymer is treated with hot water, the water-soluble polymer easily elutes from the alumina gel coating, resulting in an increased reaction surface area of the alumina gel coating with hot water. This makes it possible to form the petal-like alumina coating at relatively low temperatures for a short period of time. The roughness of the petal-like alumina coating can be controlled by selecting the type and molecular weight of the water-soluble polymer added. The amount of the water-soluble polymer added may be 0.1-10% by mass per the amount of alumina calculated assuming that all the aluminum alkoxide is converted to alumina.

The coating method includes dipping, spin coating, nozzle flow coating, spraying, reverse-coating, flexographic printing, flow coating, etc. Preferable among them is the dipping, because it can easy control the uniformity, thickness, etc. of the coating. The thickness of the resultant gel coating can be controlled by adjusting a lifting speed in the dipping, the rotation speed of the reflecting mirror substrate in the spin coating, the concentration of the coating solution, etc. The lifting speed in the dipping is preferably about 0.1-3.0 mm/second.

The drying conditions of the coating are not particularly restricted, but may be properly selected depending on the heat resistance of the reflecting mirror substrate, etc. In general, the coated, reflecting mirror substrate is treated at a temperature from room temperature to 400° C. for 5 minutes to 24 hours.

The reflecting mirror substrate provided with the alumina gel coating is treated with hot water. The hot water temperature may be properly selected depending on the heat resistance of the reflecting mirror substrate. In the case of immersion in hot water, the treatment is conducted preferably at a temperature from about 50° C. to about 100° C. for about 1-240 minutes. The temperature of drying (baking) after the hot water treatment is preferably from room temperature to 400° C., more preferably 100-400° C. The drying (baking) time is preferably from 10 minutes to 24 hours. The petal-like alumina coating thus formed is usually colorless and highly transparent.

(b) Formation of Zinc Compound Coating

The zinc compound coating is obtained by applying a solution or dispersion containing a zinc compound to the reflecting mirror substrate, drying it to form a gel coating, and treating the gel coating with water at 20° C. or higher. Because this method can form the zinc compound coating at relatively low temperatures, the zinc compound coating can be formed even on a reflecting mirror substrate without heat resistance.

The zinc compound includes zinc acetate, zinc chloride, zinc nitrate, zinc stearate, zinc oleate, zinc salicylate, etc. Among them, zinc acetate and zinc chloride are preferable. The zinc compound coating may contain at least one optional component selected from the group consisting of aluminum alkoxides, zirconium alkoxides, alkoxyl silanes and titanium alkoxides.

The aluminum alkoxides, the zirconium alkoxides, the alkoxyl silanes and the titanium alkoxides may be the same as described above. The amount of the optional component is preferably 0.01-50% by mass, more preferably 0.05-30% by mass, based on 100% by mass of the total of the zinc compound and the optional component.

The solvent and applying method of the coating solution for the zinc compound coating may be the same as those for the petal-like alumina coating. The molar ratio of (zinc compound+optional component) to the solvent is preferably 1:10-20. The coating solution may contain the above stabilizing agent and catalyst and water, if necessary. After coating, drying may be conducted at room temperature for about 30 minutes, and heat drying may be conducted, if necessary.

The dried gel coating is treated with water at 20° C. or higher. This treatment loosens a surface layer of the gel coating to cause structural rearrangement, such that zinc oxide and/or zinc hydroxide or their hydrates are deposited and grow on the surface layer of the gel coating. The water temperature is preferably 20-100° C. The water treatment time is preferably from about 5 minutes to about 24 hours. The zinc compound coating thus formed is usually colorless and highly transparent.

(2) Formation of Antistatic Coating

The antistatic coating constituted by a conductive, inorganic material layer can be produced by physical vapor deposition such as vacuum deposition, sputtering, ion-plating, etc., or chemical vapor deposition such as thermal CVD, plasma CVD, optical CVD, etc. The antistatic coating constituted by a composite layer of fine, conductive, inorganic particles and a binder can be produced by a wet method such as dipping, spin coating, spraying, roll coating, screen printing, etc.

(a) Formation of Conductive, Inorganic Material Layer

In the formation of the conductive, inorganic material layer by vapor deposition, for instance, the conductive, inorganic material is evaporated in vacuum and deposited on the reflecting mirror substrate to form the conductive inorganic material layer. The conductive, inorganic material may be evaporated by heat from a current-heating source, electron beams from an E-type electron gun, large-current electron beams by hollow cathode discharge, laser abrasion by laser pulse, etc. The conductive, inorganic material layer having the desired thickness can be formed by properly setting vapor deposition time, heating temperature, etc.

(b) Formation of Inorganic Particles-Binder Composite Layer

(i) Preparation of Slurry Containing Fine, Conductive, Inorganic Particles

In the formation of the inorganic particles-binder composite layer by a coating method, for instance, the fine, conductive, inorganic particles preferably have an average diameter of about 5-80 nm. When the average diameter is more than 80 nm, the resultant antistatic coating has too low transparency. The fine, conductive, inorganic particles having an average diameter of less than 5 nm cannot easily be produced.

The mass ratio of the fine, conductive, inorganic particles to the binder is preferably 0.05-0.7. When this mass ratio is more than 0.7, it is difficult to form a uniform coating, and the resultant layer is too brittle. When the mass ratio is less than 0.05, the resultant layer has too low conductivity.

The use of metal alkoxides or their oligomers or ultraviolet- or heat-curable compounds as binders makes it possible to form the antistatic coating even on the reflecting mirror substrate without heat resistance.

The metal alkoxides are preferably alkoxyl silanes, zirconium alkoxides, titanium alkoxides and aluminum alkoxides as described above, more preferably alkoxyl silanes.

The ultraviolet- or heat-curable compounds include radically polymerizable compounds, cationically polymerizable compounds, anionically polymerizable compounds, etc., which may be used in combination.

The radically polymerizable compounds are preferably acrylic acid and its esters, specific examples of which include (meth)acrylic acid; mono-functional (meth)acrylates such as 2-hydroxyethyl(meth)acrylate, 2-hydroxypropyl(meth)acrylate, hydroxybutyl(meth)acrylate, 2-hydroxy-3-phenoxypropyl(meth)acrylate, carboxypolycaprolactone(meth)acrylate and (meth)acrylamide; di(meth)acrylates such as pentaerythritol di(meth)acrylate, ethyleneglycol di(meth)acrylate and pentaerythritol di(meth)acrylate monostearate; tri(meth)acrylates such as trimethylol propane tri(meth)acrylate and pentaerythritol tri(meth)acrylate; poly-functional (meth)acrylates such aspentaerythritol tetra(meth)acrylate and dipentaerythritol penta(meth)acrylate; and oligomers obtained by their polymerization.

The cationically polymerizable compounds are preferably epoxy compounds, specific examples of which include phenyl glycidyl ether, ethyleneglycol diglycidyl ether, glycerin diglycidyl ether, vinyl cyclohexene dioxide, 1,2,8,9-diepoxylimonene, 3,4-epoxycyclohexylmethyl 3′,4′-epoxycyclohexane carboxylate and bis(3,4-epoxycyclohexyl)adipate.

When a metal alkoxide is used as a binder, water and a catalyst are added to a slurry containing fine, inorganic particles. The catalyst may be the same as used to form the petal-like alumina coating. The amounts of water and the catalyst added may also be the same as those for the petal-like alumina coating.

When the radically polymerizable compound or the cationically polymerizable compound is used as a binder, a radical polymerization initiator or a cationic polymerization initiator is added to a slurry containing fine, inorganic particles. The radical polymerization initiator may be a compound generating radicals by ultraviolet irradiation. Preferred examples of the radical polymerization initiator include benzyls, benzophenones, thioxanthones, benzyl dimethyl ketals, α-hydroxyalkyl phenones, hydroxyketones, amino alkyl phenones and acyl phosphine oxides. The amount of the radical polymerization initiator added is about 0.1-20 parts by mass per 100 parts by mass of the radically polymerizable compound.

The cationic polymerization initiator may be a compound generating cations by ultraviolet irradiation. Examples of the cationic polymerization initiator include onium salts such as diazonium salts, sulfonium salts, iodonium salts, etc. The amount of the cationic polymerization initiator added is about 0.1-20 parts by mass per 100 parts by mass of the cationically polymerizable compound.

Two or more types of fine, inorganic particles and binders may be added to the slurry. Usual additives such as a dispersant, a stabilizing agent, a viscosity-adjusting agent, a coloring agent, etc. may be used within ranges not deteriorating the properties.

The concentration of the slurry affects the layer thickness. Examples of the solvent contained in the slurry include alcohols such as methanol, ethanol, n-propanol, i-propanol, n-butanol, 2-butanol, i-butanol and t-butanol; alkoxyl alcohols such as 2-ethoxyethanol, 2-butoxyethanol, 3-methoxypropanol, 1-methoxy-2-propanol and 1-ethoxy-2-propanol; ketols such as diacetone alcohol; ketones such as acetone, methyl ethyl ketone and methyl i-butyl ketone; aromatic hydrocarbons such as toluene and xylene; esters such as ethyl acetate and butyl acetate. The amount of the solvent used is about 20-10,000 parts by mass per 100 parts by mass of the total of the fine, inorganic particles and the binder.

(ii) Coating

The coating method of the slurry containing fine, conductive, inorganic particles may be the same as in the formation of the petal-like alumina coating.

The binder in the slurry containing fine, conductive, inorganic particles layer is polymerized to cure the coating layer. When the binder is metal alkoxide or its oligomer, curing is conducted at a temperature of 80-400° C. for 30 minutes to 10 hours. When the binder is ultraviolet-curable, UV is irradiated at about 50-3,000 mJ/cm² to polymerize the binder, thereby forming a layer comprising the fine, conductive, inorganic particles and the binder. The irradiation time is usually about 0.1-60 seconds, though variable depending on the layer thickness.

The solvent is evaporated from the slurry containing fine, conductive, inorganic particles. The evaporation of the solvent may be conducted by keeping the slurry at room temperature, or by heating it to about 30-100° C.

(3) Formation of Water/Oil-Repellent Coating

The water/oil-repellent coating is formed by a fluorine-containing organic compound, fluorine-containing inorganic compound, a fluorine-containing organic-inorganic hybrid polymer, or fluorinated pitch. Among them, the water/oil-repellent coating made of the fluorine-containing organic compound can be produced by a wet method such as a coating method or a chemical vapor deposition method. The water/oil-repellent coating made of the fluorine-containing inorganic compound can be produced by a physical vapor deposition method or a chemical vapor deposition method in the same manner as in the antistatic coating. The water/oil-repellent coating made of the fluorine-containing organic-inorganic hybrid polymer can be produced in the same manner as in the petal-like alumina coating except for using, for instance, a fluorine-containing silane compound represented by the formula (8) above. The water/oil-repellent coating made of the fluorinated pitch can be produced by applying a fluorinated pitch solution. Thus, taking the formation of the water/oil-repellent coating of the fluorine-containing organic-inorganic hybrid polymer (fluororesin layer) by a coating method for example, detailed explanation will be made below.

(a) Preparation of Fluorine-Containing Composition Solution

To form the fluororesin layer, (i) a solution of a composition comprising a fluorine-containing olefinic polymer and a cross-linking compound may be applied to the reflecting mirror substrate, and then cross-linked, or (ii) a solution of a composition comprising a fluorine-containing olefinic monomer, a comonomer, etc. may be applied to the reflecting mirror substrate, and then polymerized. The formation of the fluororesin layer using the fluorine-containing composition is described in detail in JP 07-126552 A, JP 11-228631 A and JP 11-337706 A.

The fluororesin or the fluorine-containing composition is mixed with a proper solvent. The preferred solvents are ketones such as methyl ethyl ketone, methyl i-butyl ketone and cyclohexanone, and esters such as ethyl acetate and butyl acetate. The concentration of the fluorine-containing olefinic polymer or monomer is preferably 5-80% by mass.

(b) Coating

Because the fluororesin layer is formed substantially in the same manner as the above fine, inorganic particles-binder composite layer except for using the fluorine-containing composition solution, only differences will be explained below. The formed fluorine-containing composition solution layer is cross-linked or polymerized. When the fluorine-containing olefinic monomer or the cross-linking compound is thermally curable, heating is conducted preferably at 100-140° C. for about 30-60 minutes. When the fluorine-containing olefinic monomer or the cross-linking compound is ultraviolet-curable, UV irradiation is conducted at about 50-3,000 mJ/cm². The irradiation time is usually about 0.1-60 seconds, though changeable depending on the layer thickness.

(4) Other Treatments

Before forming the dust-proof coating, the antistatic coating and the water/oil-repellent coating, an underlying substrate or layer may be treated with corona discharge or plasma to remove moisture and impurities, thereby activating the surface. This treatment improves the bonding strength of each coating.

[3] Properties of Dust-Proof, Reflecting Mirror

The dust-proof, reflecting mirror of the present invention has the following properties.

(1) Its outermost surface has three-dimensional, average surface roughness SRa of preferably 1-100 nm, more preferably 8-80 nm, particularly 10-50 nm.

(2) Its outermost surface has a specific surface area S_{R} of preferably 1.05 or more, more preferably 1.15 or more.

[4] Optical Apparatus

The above dust-proof, reflecting mirror is suitable for an optical apparatus. The optical apparatus that may comprise the dust-proof, reflecting mirror of the present invention includes a single-lens-reflection camera; projectors such as a front projector and a rear projector; image-reading apparatuses in copiers, facsimiles, scanners, etc.

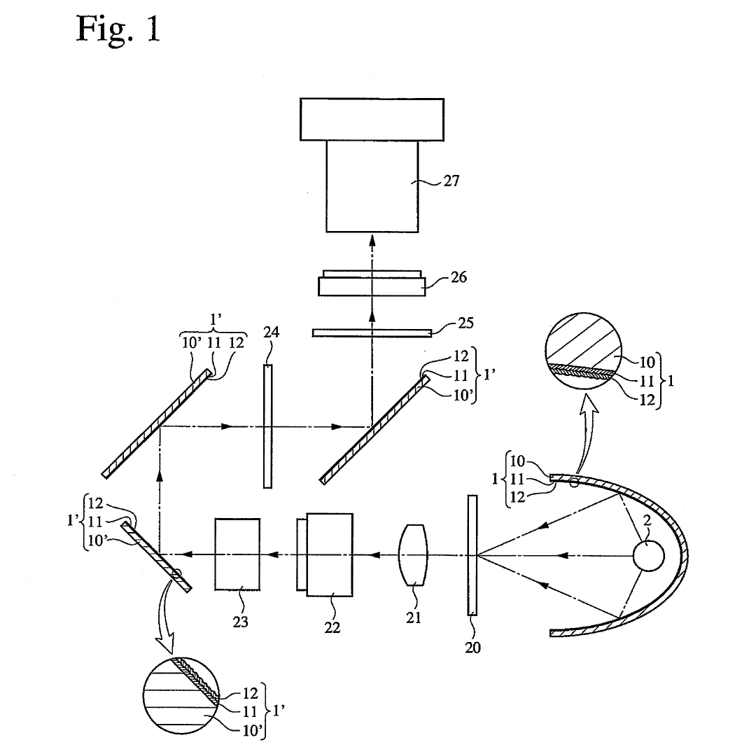

The shape, size and position of the dust-proof, reflecting mirror may be properly set, depending on the optical apparatus in which the dust-proof, reflecting mirror is used. FIG. 1 shows an example of optical engines for a liquid-crystal-type rear projector comprising the dust-proof, reflecting mirror. In this optical engine, light from a lamp 2 is focused by an elliptic reflecting mirror 1 having a dust-proof coating 11 and a water/oil-repellent coating 12, passes through an ultraviolet filter 20, and is turned to a substantially parallel light by a relay lens 21. It is then turned to a P wave by a PS synthesizing element 22, and corrected with respect to the non-uniformity of brightness by an integrator 23. The light passing through the integrator 23 is reflected by two planar reflecting mirrors 1′, 1′ each having a dust-proof coating 11 and a water/oil-repellent coating 12, and turned to a parallel light again by a Fresnel lens 24. The parallel light passes through a planar reflecting mirror 1′ having a dust-proof coating 11 and a water/oil-repellent coating 12, and a polarizing plate 25, and enters a liquid crystal panel 26. Image formed on the liquid crystal panel 26 is projected on a screen by a projection lens 27.

The dust-proof, elliptic reflecting mirror 1 comprises the dust-proof coating 11 and the water/oil-repellent coating 12 on the elliptic reflecting mirror substrate 10 made of aluminum, etc. The dust-proof planar reflecting mirror 1′ comprises the dust-proof coating 11 and the water/oil-repellent coating 12 on the planar reflecting mirror substrate 10′ comprising, for instance, a glass substrate and an aluminum layer. In the depicted example, both elliptic reflecting mirror substrate 10 and planar reflecting mirror substrate 10′ have the dust-proof coating 11 and the water/oil-repellent coating 12, but only one of them may have the dust-proof coating 11 and the water/oil-repellent coating 12.

The present invention will be explained in more detail referring to Examples below without intention of restricting the scope of the present invention.

### EXAMPLE 1

(1) Formation of Reflecting Mirror Substrate

An aluminum layer having a physical thickness of 120 nm was formed on one surface of a borosilicate crown glass plate (BK7) of 22 mm×2.8 mm×1.60 mm by a vapor deposition method, to provide a reflecting mirror substrate.

(2) Formation of Antistatic Coating

50 g of γ-glycidoxypropyltrimethoxysilane was mixed with 10 g of ethanol and 15 g of hydrochloric acid (0.01N), and stirred at room temperature to cause hydrolysis. 50 g of an Sb₂O₅ sol [“AMT130” (solid content: 20% by mass), available from Nissan Chemical Industries, Ltd.] and 10 g of ethanol were added to the resultant solution to prepare an antistatic solution. This antistatic solution was applied to the aluminum layer of the reflecting mirror substrate by a dipping method, and heat-cured at 130° C. for 3 hours to form an antistatic coating having a thickness of 1 μm and surface resistivity of 1×10¹⁰ Ω/square.

(2) Formation of Petal-Like Alumina Coating

200 g of aluminum-sec-butoxide was mixed with 700 g of sufficiently dehydrated isopropanol in an atmosphere adjusted to low humidity, sufficiently stirred at room temperature, mixed with 105 g of ethyl acetoacetate, and then stirred for 3 hours. Further, 300 g of isopropanol was mixed with 45 g of water and stirred in the same atmosphere. The resultant aqueous isopropanol solution was added to the aluminum-sec-butoxide solution, and stirred at room temperature for 24 hours to prepare a coating solution. The coating solution was applied to the antistatic coating of the reflecting mirror substrate by a dipping method, and heat-cured at 150° C. for 2 hours to form a transparent alumina gel coating on the antistatic coating. The reflecting mirror substrate having the alumina gel coating was immersed in boiling distilled water for 10 minutes, and heat-dried at 150° C. for 30 minutes to turn the alumina gel coating to a petal-like alumina coating having three-dimensional, average surface roughness SRa of 40 nm and a specific surface area S_{R} of 2.18.

(4) Formation of Water/Oil-Repellent Coating

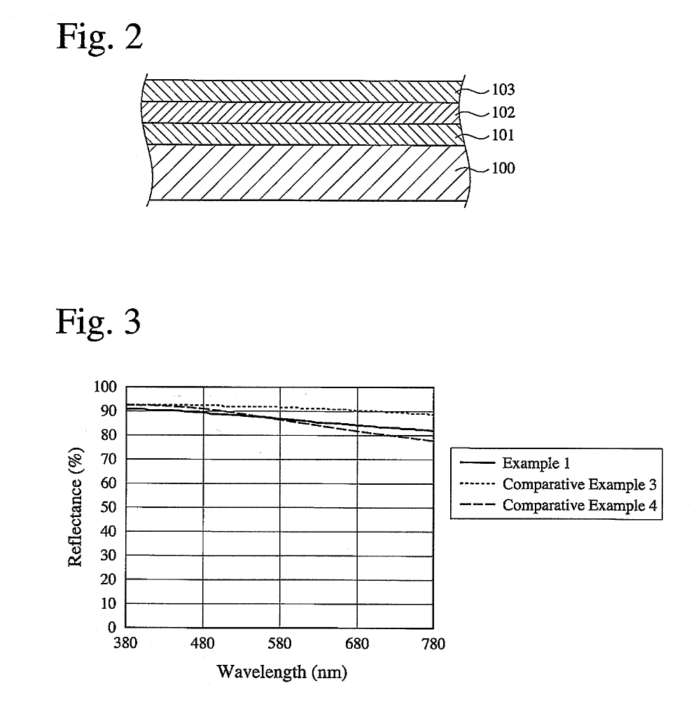

A commercially available, fluorine-containing, water-repelling agent (“OF-110” available from Canon Optron, Inc.) was evaporated by a resistance-heating method, and deposited as a water/oil-repellent coating having a thickness of 0.05 μm and a refractive index of 1.42 on the petal-like alumina coating. As shown in FIG. 2, the resultant dust-proof, reflecting mirror had an antistatic coating 101, a petal-like alumina coating 102, and a water/oil-repellent coating 103 formed in this order on the mirror substrate 100. The outermost surface of the dust-proof, reflecting mirror had SRa of 40 nm and S_{R} of 2.18, with the contact angle of pure water being 140°.

### EXAMPLE 2

A dust-proof, reflecting mirror having an antistatic coating 101, a petal-like alumina coating 102, and a water/oil-repellent coating 103 having a thickness of 0.05 μm and a refractive index of 1.38 was produced in the same manner as in Example 1, except that an ITO coating having a thickness of 0.1 μm and surface resistivity of 1×10⁴ Ω/square was formed as the antistatic coating 101 by a vapor deposition method. The outermost surface of the dust-proof, reflecting mirror had SRa of 21 nm and S_{R} of 1.43, with the contact angle of pure water being 140°.

### EXAMPLE 3

A dust-proof, reflecting mirror having a petal-like alumina coating 102 having SRa of 28 nm and S_{R} of 1.71, and a water/oil-repellent coating 103 was produced in the same manner as in Example 1, except that an antistatic coating was not formed. The contact angle of pure water was 150° on the outermost water/oil-repellent coating 103.

### COMPARATIVE EXAMPLE 1

A dust-proof, reflecting mirror having an antistatic coating 101 and a petal-like alumina coating 102 having SRa of 34 nm and S_{R} of 1.94 was produced in the same manner as in Example 1, except that a water/oil-repellent coating was not formed. The contact angle of pure water was 5° on the outermost petal-like alumina coating 102.

### COMPARATIVE EXAMPLE 2

A dust-proof, reflecting mirror having a petal-like alumina coating 102 having SRa of 29 nm and S_{R} of 1.78, the contact angle of pure water being 5°, was produced in the same manner as in Example 1, except that an antistatic coating and a water/oil-repellent coating were not formed.

### COMPARATIVE EXAMPLE 3

An aluminum layer having a physical thickness of 120 nm was formed on one surface of the same BK7 plate as above by a vapor deposition method, to produce a reflecting mirror. The aluminum layer had SRa of 0.4 nm and S_{R} of 1.00, the contact angle of pure water being 10°.

### COMPARATIVE EXAMPLE 4

An aluminum layer having a physical thickness of 120 nm was formed on one surface of the same BK7 plate as above by a vapor deposition method, and a SiO₂ coating having a physical thickness of 120 nm was formed on the aluminum layer by a vapor deposition method to provide a reflecting mirror. The SiO₂ coating had SRa of 0.4 nm and S_{R} of 1.00, the contact angle of pure water being 15°.

The layer structures of the reflecting mirrors of Examples 1-3 and Comparative Examples 1-4, and the SRa, S_{R}, and the contact angle of pure water on their outermost surfaces are shown in Table 1.

The dust-proof, reflecting mirror of Example 1, and the reflecting mirrors of Comparative Examples 3 and 4 were measured with respect to reflectance by a reflectance meter of a USPM type available from Olympus Corporation (wavelength: 380-780 nm). The results are shown in FIG. 3. The average reflectance was 86.58% in the dust-proof, reflecting mirror of Example 1, 91.12% in the reflecting mirror of Comparative Example 3, and 86.19% in the reflecting mirror with the SiO₂ coating of Comparative Example 4. The dust-proof, reflecting mirror of Example 1 had reflectance comparable to that of the reflecting mirrors of Comparative Examples 3 and 4.

The dust resistance of each reflecting mirror was evaluated by the following method. Each reflecting mirror was placed upright in a cylindrical container having a volume of 1,000 cm³ and a diameter of 95 mm. 5.5 mg of silica (SiO₂) sand particles having a specific gravity of 2.6 g/cm³ and a diameter distribution range of 30-300 μm were uniformly scattered in the container, and left to stand for 1 hour. The number of silica sand particles attached to the reflecting mirror surface was counted. The measurement was conducted at a temperature of 25° C. and relative humidity (RH) of 50%. This test was repeated 30 times. The results are shown in Table 1.

TABLE 1

| | No. | | | |
|---|---|---|---|---|
| | Example 1 | Example 2 | Example 3 | Com. Ex. 1 |
| Antistatic Coating | Hydrolyzate | Vapor | — | Hydrolyzate |
| | of γ-GMS⁽¹⁾ + | Deposited | | of γ-GMS⁽¹⁾ + |
| | Sb₂O₅ | ITO | | Sb₂O₅ |
| | sol | | | sol |
| Dust-Proof Coating | Petal-Like | Petal-Like | Petal-Like | Petal-Like |
| | Alumina | Alumina | Alumina | Alumina |
| | Coating | Coating | Coating | Coating |
| Water/Oil-Repellent Coating | OF-110 | OF-110 | OF-110 | — |
| Outermost Surface | | | | |
| Sra (nm) | 40 | 21 | 28 | 34 |
| S_{R} | 2.18 | 1.43 | 1.71 | 1.94 |
| Contact Angle (°) of Pure Water | 140 | 140 | 150 | 5 |
| Silica Sand Particles Attached | | | | |
| 30 μm ≦ N⁽²⁾ < 50 μm | 1,790 | 1,779 | 951 | 2,844 |
| 50 μm ≦ N < 100 μm | 507 | 489 | 226 | 820 |
| 100 μm ≦ N < 200 μm | 11 | 8 | 7 | 16 |
| 200 μm ≦ N ≦ 300 μm | 0 | 2 | 1 | 1 |
| N_{T}⁽³⁾ | 2,308 | 2,278 | 1,185 | 3,681 |
| Nav⁽⁴⁾ | 76.9 | 75.9 | 39.5 | 122.7 |

| | No. | | |
|---|---|---|---|
| | Com. Ex. 2 | Com. Ex. 3 | Com. Ex. 4 |
| Antistatic Coating | — | — | — |
| Dust-Proof Coating | Petal-Like | — | — |
| | Alumina | | |
| | Coating | | |
| Water/Oil-Repellent Coating | — | — | — |
| Outermost Surface | | | |
| Sra (nm) | 29 | 0.4 | 0.4 |
| S_{R} | 1.78 | 1.00 | 1.00 |
| Contact Angle (°) of Pure Water | 5 | 10 | 15 |
| Silica Sand Particles Attached | | | |
| 30 μm ≦ N⁽²⁾ < 50 μm | 2,940 | 10,258 | 8,454 |
| 50 μm ≦ N < 100 μm | 750 | 4,558 | 2,873 |
| 100 μm ≦ N < 200 μm | 20 | 163 | 75 |
| 200 μm ≦ N ≦ 300 μm | 0 | 15 | 6 |
| N_{T}⁽³⁾ | 3,710 | 14,994 | 11,408 |
| Nav⁽⁴⁾ | 123.7 | 499.8 | 380.3 |

Note:
⁽¹⁾γ-Glycidoxypropyltrimethoxysilane.
⁽²⁾The total number of silica sand particles in each diameter range attached to the reflecting mirror in 30 tests.
⁽³⁾The total number of silica sand particles attached to the reflecting mirror in 30 tests.
⁽⁴⁾The average number of silica sand particles attached to the reflecting mirror in 30 tests.

The dust-proof, reflecting mirrors of Examples 1-3 had excellent dust resistance because of the petal-like alumina coating and the water/oil-repellent coating. On the other hand, the dust-proof, reflecting mirrors of Comparative Examples 1 and 2 having the petal-like alumina coating without the water/oil-repellent coating had poor dust resistance, suffering large numbers of silica sand particles attached. Also, the reflecting mirrors of Comparative Examples 3 and 4 not having the petal-like alumina coating and the water/oil-repellent coating had extremely poor dust resistance, suffering remarkably large numbers of silica sand particles attached.

### EFFECT OF THE INVENTION

In the dust-proof, reflecting mirror of the present invention, an intermolecular force and an attraction force by contact electrification are reduced between the dust-proof, reflecting mirror and dust particles attached thereto because of having the dust-proof coating having fine surface roughness, and a liquid bridge force is reduced between the dust-proof, reflecting mirror and dust particles because of having the water/oil-repellent coating as an outermost surface without losing the fine roughness. Accordingly, the dust-proof, reflecting mirror of the present invention has excellent dust resistance. Further, the dust-proof, reflecting mirror provided with an antistatic coating has further improved dust resistance, because the electrostatic attraction force and electric imaging force of dust particles are reduced. The optical apparatus comprising the dust-proof, reflecting mirror of the present invention having such excellent dust resistance does not need a closed dust-proof structure and a mechanical dust-proof means, achieving low cost, light weight and low power consumption.

The present disclosure relates to subject matter contained in Japanese Patent Application No. 2007-039661 filed on Feb. 20, 2007, which is expressly incorporated herein by reference in its entirety.

What is claimed is:

1. A dust-proof, reflecting mirror comprising a reflecting mirror substrate, a dust-proof coating having fine surface roughness, which is formed on a reflecting surface of the reflecting mirror substrate, and an outermost water-repellent or water/oil-repellent coating.

2. The dust-proof, reflecting mirror according to claim 1, wherein said dust-proof coating comprises at least one selected from the group consisting of alumina, zinc oxide and zinc hydroxide.

3. The dust-proof, reflecting mirror according to claim 2, wherein the roughness of said dust-proof coating is constituted by large numbers of irregularly distributed projections having a petal-like shape and grooves therebetween.

4. The dust-proof, reflecting mirror according to claim 1, which further comprises an antistatic coating as a primer layer for said dust-proof coating.

5. The dust-proof, reflecting mirror according to claim 4, wherein said antistatic coating has surface resistivity of 1×10¹³ Ω/square or less.

6. The dust-proof, reflecting mirror according to claim 1, wherein said water-repellent or water/oil-repellent coating has a thickness of 0.4-100 nm.

7. The dust-proof, reflecting mirror according to claim 1, which has an outermost surface having three-dimensional, average surface roughness of 1-100 nm.

8. The dust-proof, reflecting mirror according to claim 1, wherein said outermost surface has a specific surface area of 1.05 or more.

9. An optical apparatus comprising a dust-proof, reflecting mirror, the dust-proof, reflecting mirror comprising a reflecting mirror substrate, a dust-proof coating having fine surface roughness, which is formed on a reflecting surface of the reflecting mirror substrate, and an outermost water-repellent or water/oil-repellent coating.
